(19) United States
(12) Patent Application Publication
(10) Pub. No.: US 2018/0260889 A1
(43) Pub. Date: Sep. 13, 2018

(54) Sourcing Mortgage Documents via Blockchains

(71) Applicant: Factom, Austin, TX (US)

(72) Inventors: Mahesh Paolini-Subramanya, Austin, TX (US); Brain Deery, Austin, TX (US); Paul Snow, Austin, TX (US); Jason Nadeau, Missouri City, TX (US)

(21) Appl. No.: 15/456,067

(22) Filed: Mar. 10, 2017

(51) Int. Cl. G06Q 40/02; H04L 9/06; H04L 9/08; H04L 9/14

(52) U.S. Cl. CPC G06Q 40/025; H04L 9/0637; H04L 9/0643; G06Q 2220/00; H04L 9/0819; H04L 9/14; H04L 9/0861

(57) ABSTRACT

Retrieval of mortgage documents is faster and simpler for auditing purposes. Network addresses and other sourcing data may be hashed and integrated into a blockchain. The sourcing data identifies a device, server, or other network location from which the mortgage documents may be retrieved. Any auditor receiving the blockchain may thus perform a reverse lookup to retrieve the mortgage documents. The auditor merely queries for a cryptographic source key to determine the network location storing the corresponding mortgage document.

### CROSS-REFERENCE TO RELATED APPLICATIONS

This application relates to U.S. application Ser. No. 15/419,033 filed Jan. 30, 2017, to U.S. application Ser. No. 15/419,042 filed Jan. 30, 2017, to U.S. application Ser. No. 15/435,612 filed Feb. 17, 2017, and to U.S. application Ser. No. ______ filed ______ [Attorney Document Factom #4], with all applications incorporated herein by reference in their entireties.

### BACKGROUND

The mortgage industry has learned from the past. The so-called mortgage crisis of 2007 exposed flaws in the mortgage industry. Many mortgages lacked sufficient documentation, checks and balances were not implemented, and fraud was alleged.

### BRIEF DESCRIPTION OF THE SEVERAL VIEWS OF THE DRAWINGS

The features, aspects, and advantages of the exemplary embodiments are understood when the following Detailed Description is read with reference to the accompanying drawings, wherein:

FIGS. 1-5 are simplified illustrations of validating mortgage documents, according to exemplary embodiments;

FIGS. 6-9 are detailed illustrations of an operating environment, according to exemplary embodiments;

FIG. 10 illustrates document retrieval, according to exemplary embodiments;

FIG. 11 illustrates multiple document sources, according to exemplary embodiments;

FIG. 12 illustrates sequential cryptographic keys, according to exemplary embodiments;

FIG. 13 illustrates sequential assemblage, according to exemplary embodiments;

FIG. 14 is a block diagram illustrating a method or algorithm of sourcing a mortgage document, according to exemplary embodiments; and

FIGS. 15-16 depict still more operating environments for additional aspects of the exemplary embodiments.

### DETAILED DESCRIPTION

The exemplary embodiments will now be described more fully hereinafter with reference to the accompanying drawings. The exemplary embodiments may, however, be embodied in many different forms and should not be construed as limited to the embodiments set forth herein. These embodiments are provided so that this disclosure will be thorough and complete and will fully convey the exemplary embodiments to those of ordinary skill in the art. Moreover, all statements herein reciting embodiments, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, schematics, illustrations, and the like represent conceptual views or processes illustrating the exemplary embodiments. The functions of the various elements shown in the figures may be provided through the use of dedicated hardware as well as hardware capable of executing associated software. Those of ordinary skill in the art further understand that the exemplary hardware, software, processes, methods, and/or operating systems described herein are for illustrative purposes and, thus, are not intended to be limited to any particular named manufacturer.

As used herein, the singular forms “a,” “an,” and “the” are intended to include the plural forms as well, unless expressly stated otherwise. It will be further understood that the terms “includes,” “comprises,” “including,” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

It will also be understood that, although the terms first, second, etc. may be used herein to describe various elements, these elements should not be limited by these terms. These terms are only used to distinguish one element from another. For example, a first device could be termed a second device, and, similarly, a second device could be termed a first device without departing from the teachings of the disclosure.

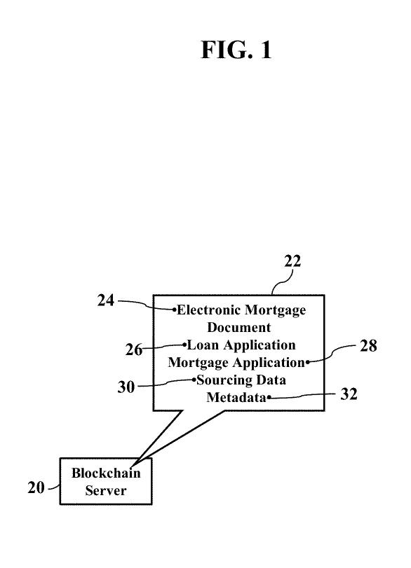

FIGS. 1-5 are simplified illustrations of sourcing mortgage documents, according to exemplary embodiments. FIG. 1 illustrates a blockchain server 20 storing electronic data 22 representing an electronic mortgage document 24. The electronic mortgage document 24 may be a part or a component of loan application 26. Indeed, many readers are likely familiar with an electronic mortgage application 28 that is processed when financing a mortgage for a home or business property. The electronic mortgage document 24, however, may be associated with any other type of loan, such as a vehicle installment, business or equipment purchase, and even equity lines of credit.

FIG. 1 also illustrates sourcing data 30. The sourcing data 30 specifies from where the electronic mortgage document 24 may be obtained. That is, the sourcing data 30 specifies a network location, address, website, and/or other information associated with a networked device or server that stores the electronic mortgage document 24. The sourcing data 30 may be as simple or detailed as needed to ease access to the electronic mortgage document 24. The sourcing data 30, for example, may be defined as [{“Source”:{“Name”: “Wells Fargo System XXX”}, {“ID”:“YYY”}, {“Access Link”:“https://foo.wellsfargo.com”} . . . ] and textually written or encoded as metadata 32. The sourcing data 30 may thus specify one or more uniform resource locators (URLs) as website links from where the corresponding electronic mortgage document 24 (document identifier “ID”:YYY″) may be queried and retrieved. The sourcing data 30, however, may be anonymized, thus not hiding or not revealing the responsible lender, data owner, or contractor [{“Source”:{“Name”: “Anonymous”}, {“ID”:“YYY” }, {“Access Link”:“https://2690:a280:7751:5507:b93z:59fg:441p:c55q”} . . . ], perhaps thus merely identifying an IP address. The sourcing data 30 may also be redacted to additionally or alternatively conceal the sourcing entity. Regardless, the sourcing data 30 may thus be populated by an originator or creator of the electronic mortgage document 24. The sourcing data 30 may also be populated by an owner of the electronic mortgage document 24 (such as lender of contractor). The sourcing data 30 may thus be added to any existing metadata 32 to accompany the electronic mortgage document 24.

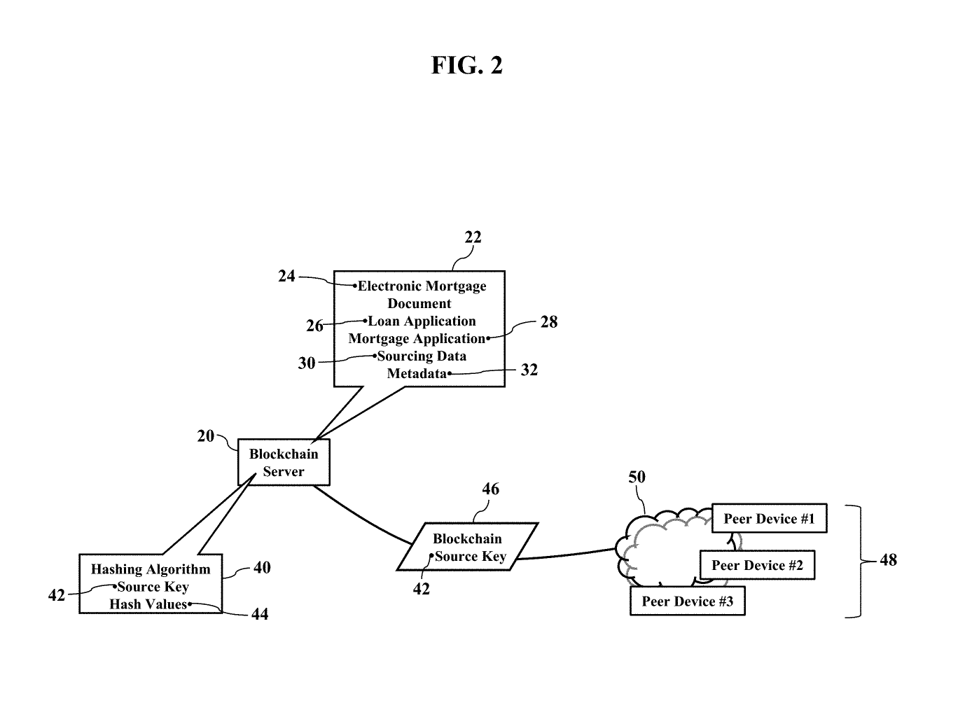

FIG. 2 illustrates secure distribution. Once the electronic mortgage document 24 is retrieved, the corresponding metadata 32 (specifying the sourcing data 30) may be hashed using a cryptographic hashing algorithm 40. This disclosure defines the term cryptographic “source key” 42 as the hash value(s) 44 generated from hashing the sourcing data 30. The cryptographic source key 42 may then be distributed via one or more blockchains 46 to one or more trusted peer devices 48. That is, the blockchain server 20 may integrate the cryptographic source key 42 into the blockchain(s) 46 and distributed via a communications network 50 to the trusted peer devices 48. Each trusted peer device 48 may thus receive the cryptographic source key 42 incorporated into the blockchain 46. The source key 42 may thus have a value that is “free form JSON” according to the JSON format.

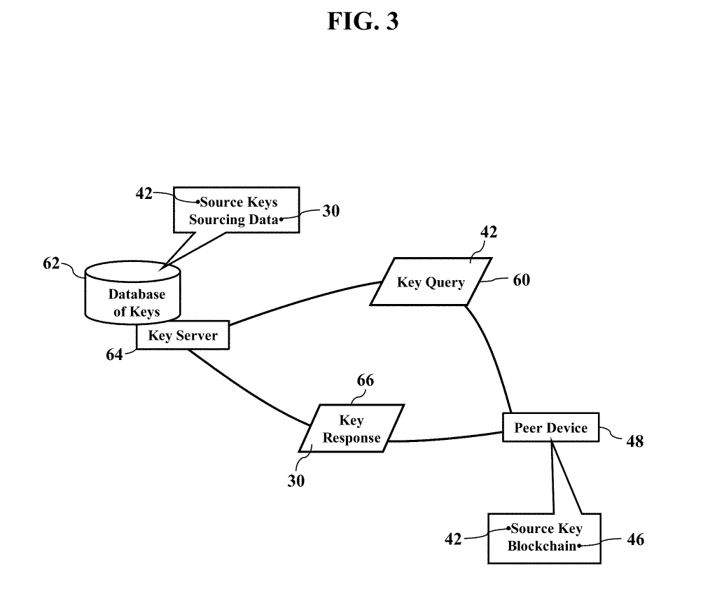

FIG. 3 illustrates sourcing discovery. Now that the trusted peer device 48 has the source key 42 (distributed via the blockchain 46), the trusted peer device 48 may easily and quickly discover the storage location of the corresponding electronic mortgage document 24. That is, the source key 42 may be used to reverse lookup the sourcing data 30. The trusted peer device 48 generates and sends a key query 60 to the network address associated with an electronic database 62 of keys. FIG. 3 illustrates a key server 64 storing or maintaining the electronic database 62 of keys. The electronic database 62 of keys, however, may be stored at maintained at any network device or location (as later paragraphs will explain). The electronic database 62 of keys stores entries that electronically associate different source keys 42 to their corresponding sourcing data 30. The trusted peer device 48 queries the key server 64 (via the communications network 50 illustrated in FIG. 2) for the source key 42 received via the blockchain 46. The key server 64 retrieves the corresponding sourcing data 30 and sends a key response 66 to the trusted peer device 48. The key response 66 includes information describing the sourcing data 30 retrieved from the electronic database 62 of keys. Exemplary embodiments thus allow the trusted peer device 48 to translate or convert the source key 42 into its corresponding sourcing data 30.

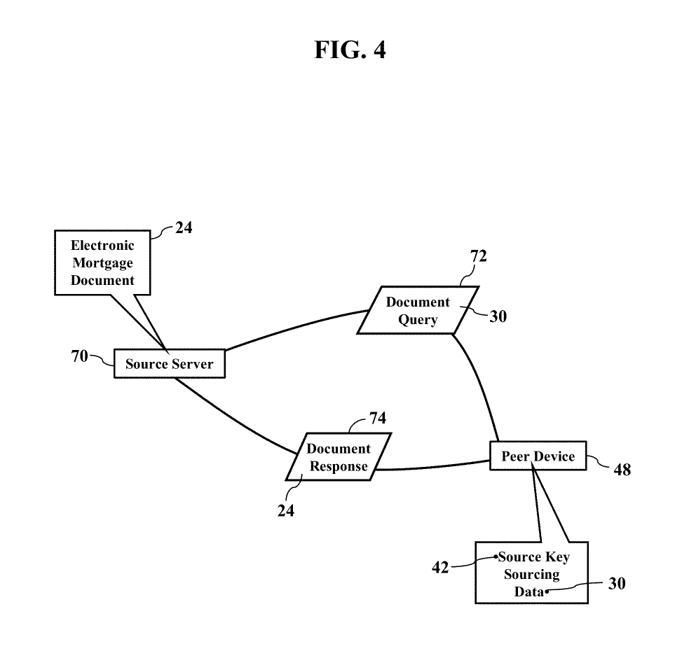

FIG. 4 illustrates source retrieval. Now that the sourcing data 30 is determined (based on the source key 42), the corresponding electronic mortgage document 24 may be obtained. Recall that the sourcing data 30 identifies the networked source that stores the electronic mortgage document 24. FIG. 4 illustrates a source server 70 storing the electronic mortgage document 24. The trusted peer device 48 need only generate and send a document query 72 specifying the sourcing data 30. The trusted peer device 48 thus receives a document response 74 containing or referencing the electronic mortgage document 24 that corresponds to the sourcing data 30.

Exemplary embodiments thus include simple auditing tools. Exemplary embodiments cryptographically hash the sourcing data 30 to generate the source key 42 for distribution via the blockchain(s) 46. Any recipient of the blockchain 46 may then simply and quickly convert the source key 42 back into the corresponding sourcing data 30. If the trusted peer device 48 is operated by or on behalf of an auditing entity, the auditor may quickly and easily use a query operation to determine the network source (e.g., the source server 70) storing any mortgage document. The auditor need only translate the source key 42 to easily retrieve mortgage documents for auditing purposes.

Exemplary embodiments may be applied to any electronic document. Most readers are thought familiar with mortgage documents. This disclosure thus mainly explains retrieval of mortgage documents. Exemplary embodiments, though, may be applied to retrieval of any electronic data representing any document.

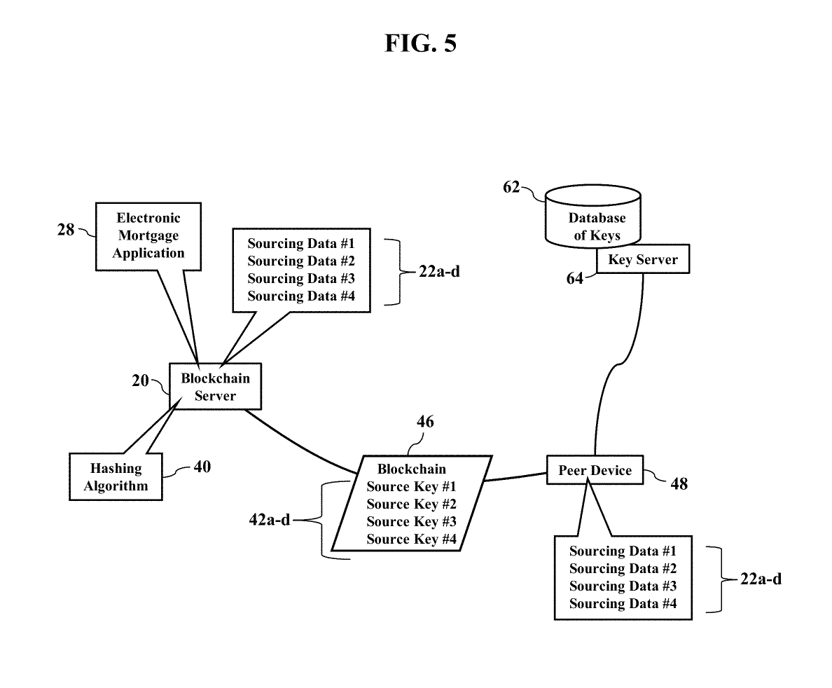

FIG. 5 illustrates multiple source keys 42a-d. Here exemplary embodiments may integrate the multiple source keys 42a-d into the blockchain 46. As the reader may understand, the electronic mortgage application 28 may contain many different, separate documents. For example, the electronic mortgage application 28 may include an applicant's tax returns, employment verification, pay stubs, bank statements, and other documents. The electronic mortgage application 28 may also contain application paperwork (such as a Uniform Residential Loan Application), purchase agreement, appraisal, title history, and still many more documents. The electronic mortgage application 28 may thus be an assemblage of different mortgage documents. For simplicity, FIG. 5 only illustrates four (4) different sourcing data 22a-d, with each individual sourcing data 22a-d corresponding to a different mortgage document. The blockchain server 20 may thus hash each one of the different sourcing data 22a-d (using the cryptographic hashing algorithm 40) to generate the multiple source keys 42a-d. The multiple cryptographic source keys 42a-d may then be distributed via the blockchain(s) 46 to the trusted peer device 48. The trusted peer device 48 may then perform multiple query operations to the key sever 64 (as earlier explained) to translate each different source key 42a-d.

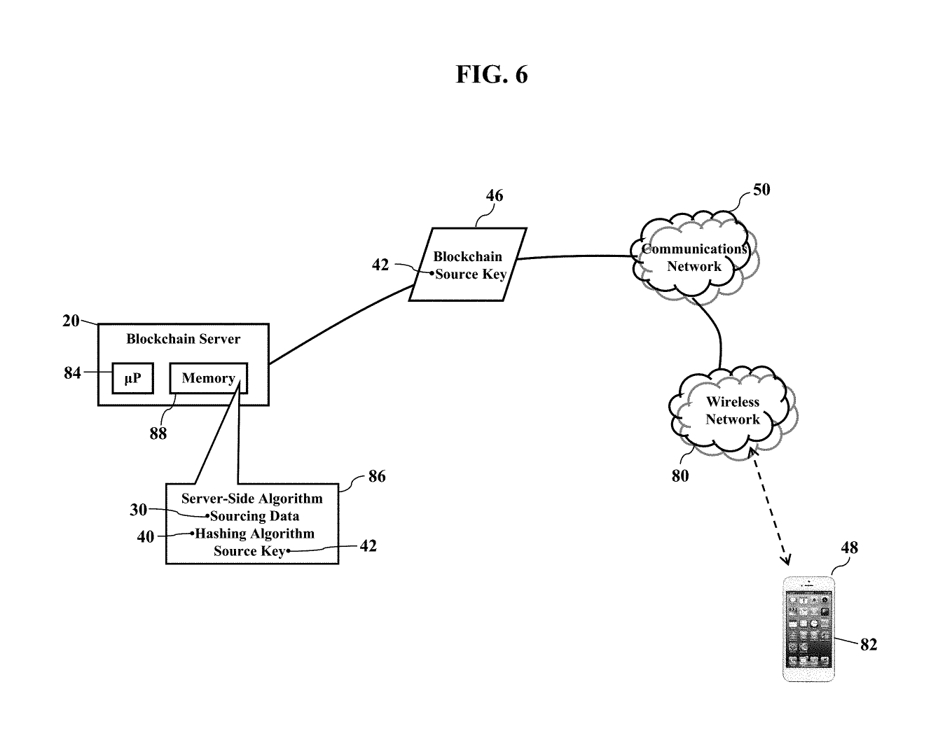

FIGS. 6-9 are detailed illustrations of an operating environment, according to exemplary embodiments. FIG. 6 illustrates the blockchain server 20 communicating with the trusted peer device 48 via the communications network 50 (and perhaps a wireless network 80). FIG. 6 illustrates the trusted peer device 48 as a mobile smartphone 82, which most readers are thought familiar. The trusted peer device 48, though, may be any processor-controlled device, as later paragraphs will explain. The blockchain server 20 may have a processor 84 (e.g., “pP”), application specific integrated circuit (ASIC), or other component that executes a server-side algorithm 86 stored in a local memory device 88. The server-side algorithm 86 includes instructions, code, and/or programs that cause the blockchain server 20 to perform operations, such as hashing the sourcing data 30 using the hashing algorithm 40 to generate the source key 42 (as the above paragraphs explained). The server-side algorithm 86 may then instruct or cause the blockchain server 20 to integrate the cryptographic source key 42 into the blockchain 46 for distribution to the mobile smartphone 82. Exemplary embodiments, though, may send the cryptographic source key 42 and/or the blockchain 46 to any IP address associated with any network destination or device.

Exemplary embodiments may use any hashing function. Many readers may be familiar with the SHA-256 hashing algorithm that generates a 256-bit hash value. Exemplary embodiments obtain or retrieve the metadata 32 representing the sourcing data 30. The SHA-256 hashing algorithm acts on the sourcing data 30 to generate a 256-bit hash value as the cryptographic source key 42. The source key 42 is thus a digital signature that uniquely represents the sourcing data 30. There are many hashing algorithms, though, and exemplary embodiments may be adapted to any hashing algorithm.

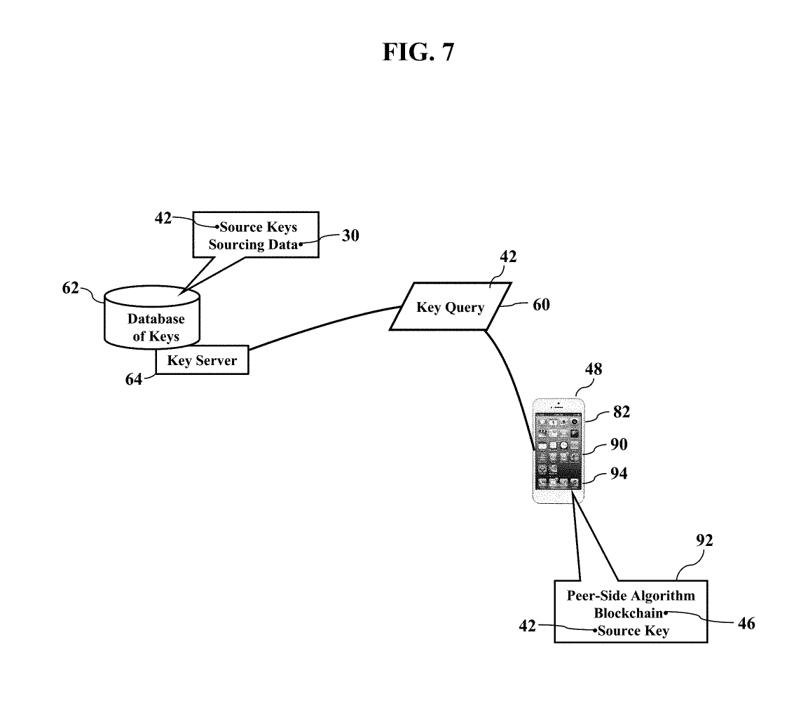

FIG. 7 illustrates sourcing conversion. Now that the blockchain 46 is distributed, the trusted peer device 48 (again illustrated as the mobile smartphone 82) may reverse convert the source key 42 into the corresponding sourcing data 30. The mobile smartphone 82 has a processor 90, application specific integrated circuit (ASIC), or other component that executes a peer-side algorithm 92 stored in a local memory device 94. The peer-side algorithm 92 includes instructions, code, and/or programs that cause the processor 90 to perform operations, such as generating and sending the key query 60 to the network address (e.g., Internet Protocol address) associated with the key server 64 storing or maintaining the electronic database 62 of keys.

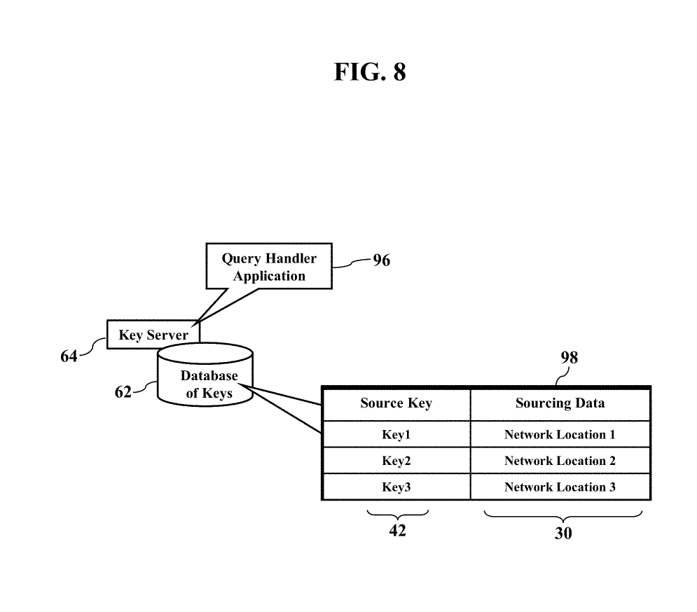

FIG. 8 further illustrates the electronic database 62 of keys. The key server 64 functions to answer queries submitted by authorized clients. That is, the key server 64 executes a query handler application 96 that accepts the source key 42 as a query term. The query handler application 96 may then search the electronic database 62 of keys for a matching entry. While the electronic database 62 of keys may have any structure, FIG. 8 illustrates the electronic database 62 of keys as a table 98 that electronically maps, relates, or associates different source keys 42 to their corresponding sourcing data 30. The electronic database 62 of keys may thus be loaded or configured with data or information for determining the retrieval locations of mortgage documents. If a match is determined, the corresponding source key 42 is identified. FIG. 8 illustrates the electronic database 62 of keys as being locally stored in the key server 62, but some of the database entries may be dispersed to multiple other devices or locations in the communications network (illustrated as reference numeral 50 in FIGS. 2 and 6). While FIG. 8 only illustrates a few entries, in practice the electronic database 62 of keys may contain hundreds, thousands, or even millions of entries detailing many mortgage documents.

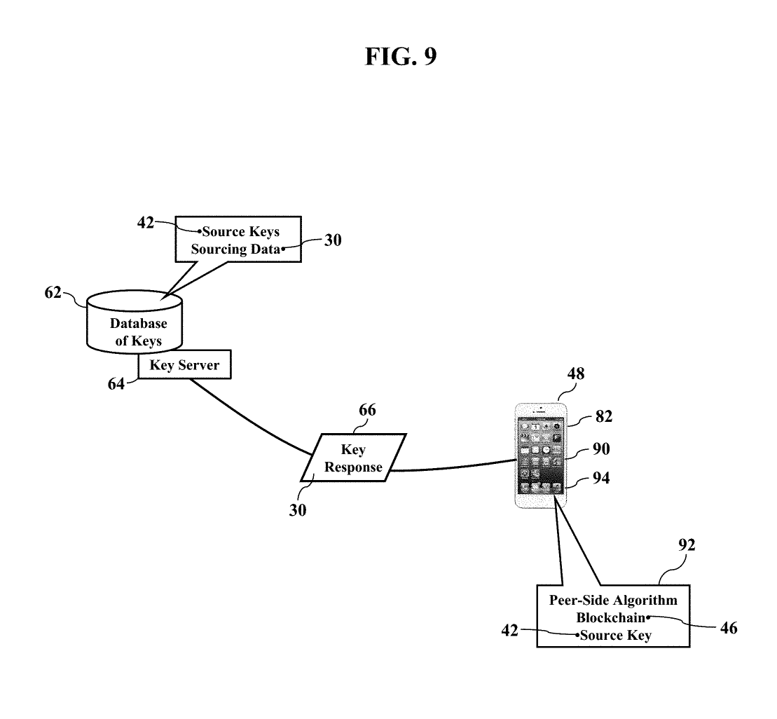

FIG. 9 illustrates database replies. The trusted peer device 48 queries the electronic database 62 of keys for the source key 42 received via the blockchain 46. The key server 62 retrieves and packages the corresponding sourcing data 30 as the key response 66. The key server 62 sends the key response 66 to the network address (e.g., IP address) associated with the trusted peer device 48 (such as the mobile smartphone 82).

Exemplary embodiments may be applied regardless of networking environment. Exemplary embodiments may be easily adapted to stationary or mobile devices having cellular, wireless fidelity (WI-FI®), near field, and/or BLUETOOTH® capability. Exemplary embodiments may be applied to mobile devices utilizing any portion of the electromagnetic spectrum and any signaling standard (such as the IEEE 802 family of standards, GSM/CDMA/TDMA or any cellular standard, and/or the ISM band). Exemplary embodiments, however, may be applied to any processor-controlled device operating in the radio-frequency domain and/or the Internet Protocol (IP) domain. Exemplary embodiments may be applied to any processor-controlled device utilizing a distributed computing network, such as the Internet (sometimes alternatively known as the “World Wide Web”), an intranet, a local-area network (LAN), and/or a wide-area network (WAN). Exemplary embodiments may be applied to any processor-controlled device utilizing power line technologies, in which signals are communicated via electrical wiring. Indeed, exemplary embodiments may be applied regardless of physical componentry, physical configuration, or communications standard(s).

Exemplary embodiments may utilize any processing component, configuration, or system. Any processor could be multiple processors, which could include distributed processors or parallel processors in a single machine or multiple machines. The processor can be used in supporting a virtual processing environment. The processor could include a state machine, application specific integrated circuit (ASIC), programmable gate array (PGA) including a Field PGA, or state machine. When any of the processors execute instructions to perform operations, this could include the processor performing the operations directly and/or facilitating, directing, or cooperating with another device or component to perform the operations.

Exemplary embodiments may packetize. The blockchain server 20 and the trusted peer device 48 may have network interfaces to the communications network 50, thus allowing collection and retrieval of information. The information may be received as packets of data according to a packet protocol (such as the Internet Protocol). The packets of data contain bits or bytes of data describing the contents, or payload, of a message. A header of each packet of data may contain routing information identifying an origination address and/or a destination address associated with any of the blockchain server 20 and the trusted peer device 48.

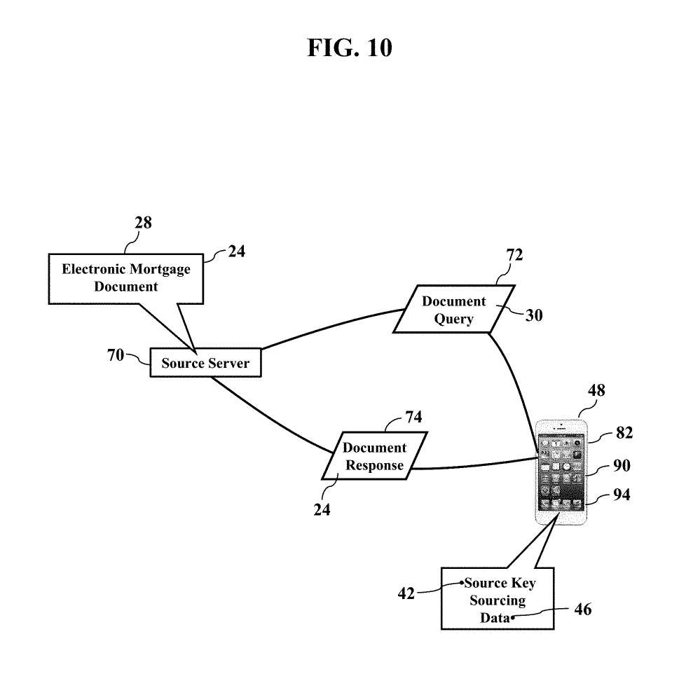

FIG. 10 illustrates document retrieval, according to exemplary embodiments. Now that the trusted peer device 48 has determined the sourcing data 30 associated with the source key 42, the trusted peer device 48 may retrieve the corresponding electronic mortgage document 24. FIG. 10 illustrates a single query operation in which the entire electronic mortgage application 28 is retrieved. That is, the sourcing data 30 identifies a network location from which all pages/documents are stored (perhaps as a single, large PDF package). The trusted peer device 48 sends the document query 72 specifying the sourcing data 30 to the source server 70. When the source server 70 receives the document query 72, the source server 70 retrieves and sends the entire electronic mortgage application 28 as the document response 74. The trusted peer device 48 has thus obtained the entire electronic mortgage application 28 in response to the source key 42 received via the blockchain 46.

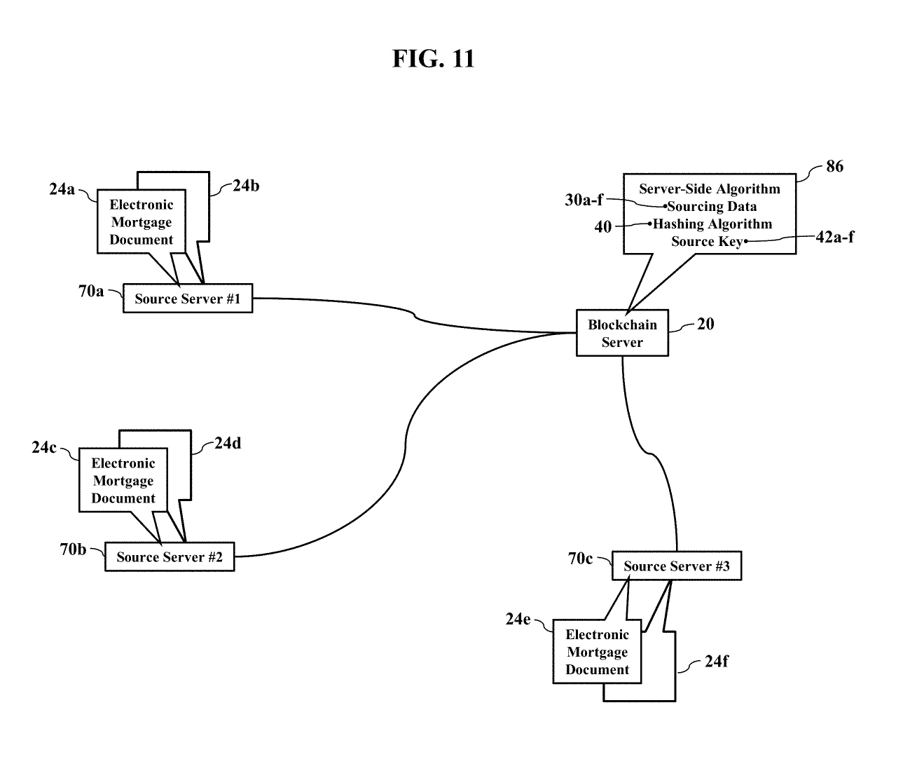

FIG. 11 illustrates multiple document sources, according to exemplary embodiments. Here the electronic mortgage application 28 may be an assemblage of individual, different electronic mortgage documents 24. Recall that the electronic mortgage application 28 may contain many different documents that are separately retrieved and assembled to create the entire electronic mortgage application 28. Some electronic mortgage documents 24a-b, for example, may be stored to source server #1 (illustrated as reference numeral 70a). Other electronic mortgage documents 24c-d may be stored to source server #2 (reference numeral 70b). Still other electronic mortgage documents 24e-f may be stored to source server #3 (reference numeral 70c). Each source server 70a-c may thus send the corresponding sourcing data 30a-f to the blockchain server 20. The blockchain server 20 thus hashes the sourcing data 30a-f (using the hashing algorithm 40) to generate the multiple source keys 42a-f.

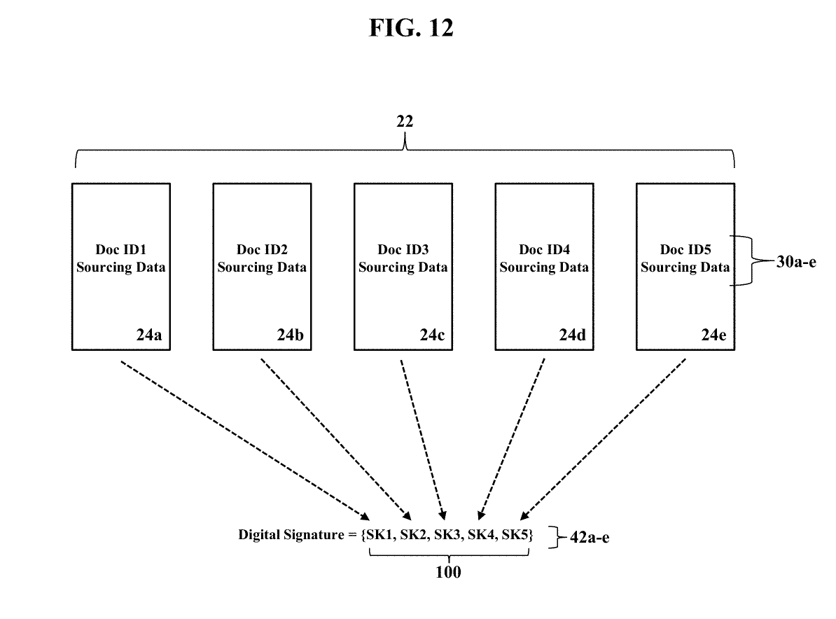

FIG. 12 illustrates sequential cryptographic keys, according to exemplary embodiments. Here exemplary embodiments may generate a series listing 100 of the multiple source keys 42a-e representing the individual electronic mortgage documents 24a-e. Again, even though the electronic mortgage application 28 may have many pages of individual, different mortgage documents, for simplicity FIG. 12 only illustrates five (5) different electronic mortgage documents 24a-e. Each document 24a-e is associated with its corresponding sourcing data 30a-e. Exemplary embodiments may hash each document's sourcing data 30a-e to generate the corresponding source key 42a-e. Exemplary embodiments may then assemble or package the multiple source keys 42a-e as the series listing 100 ({SK1, SK2, SK3, SK4, SK5}). The series listing 100 may then be distributed via the blockchain 46 (as this disclosure above explains). The trusted peer device 48 may then query the database 62 of keys to determine the corresponding sourcing data 30a-e (explained with reference to FIGS. 7-9). The trusted peer device 48 may then use the sourcing data 30a-e to retrieve each corresponding electronic mortgage document 24a-e (explained with reference to FIG. 10).

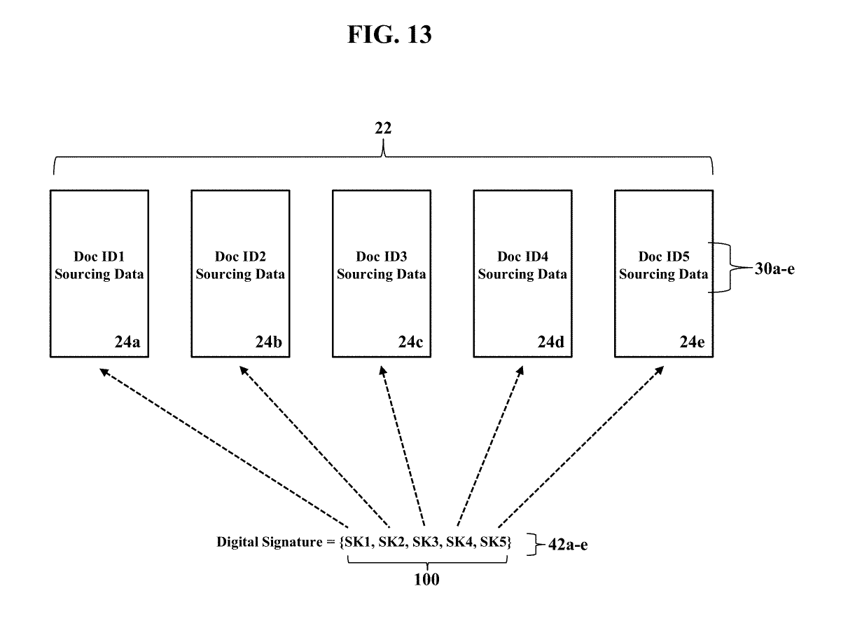

FIG. 13 illustrates sequential assemblage, according to exemplary embodiments. Here exemplary embodiments may assemble the separate electronic mortgage document 24a-e according to the series listing 100 specified by the blockchain 46. If the series listing 100 specifies the sequential order of the source keys 42a-e, then exemplary embodiments may retrieve and assemble the electronic mortgage document 24a-e in the same sequential order. The sequential order of the source keys 42a-e, in plain words, may also correspond to the sequential order of the separate electronic mortgage documents 24a-e. Exemplary embodiments may thus arrange the electronic mortgage documents 24a-e according to the series listing 100 specified by the blockchain 46.

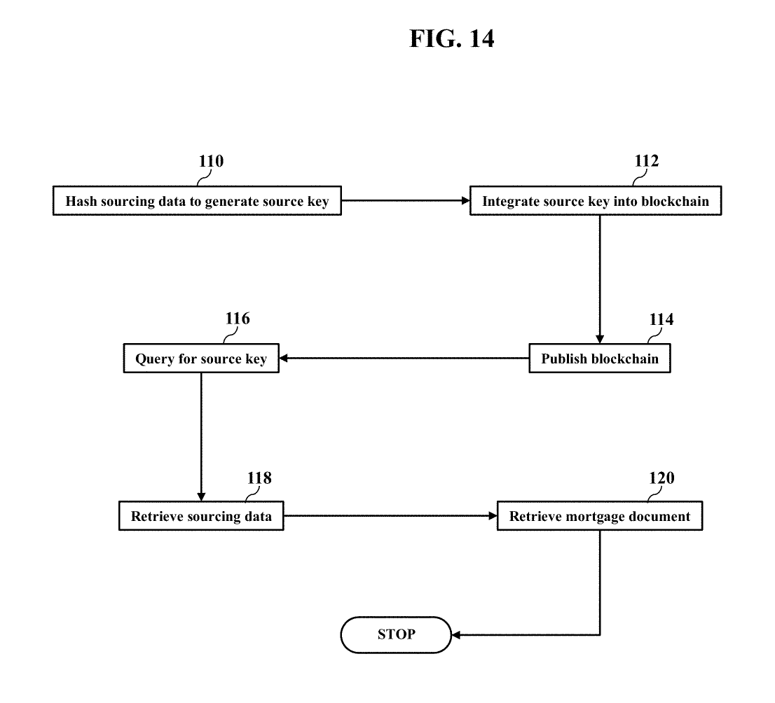

FIG. 14 is a block diagram illustrating a method or algorithm of sourcing a mortgage document, according to exemplary embodiments. The sourcing data 30 is hashed to generate the source key 42 (Block 110). The source key 42 is integrated into the blockchain 46 (Block 112) and published for distribution (Block 114). Any recipient of the blockchain 46 may thus query the electronic database 62 of keys (Block 116) and retrieve the corresponding sourcing data 30 (Block 118). The sourcing data 30 identifies the network source storing the mortgage document (Block 120).

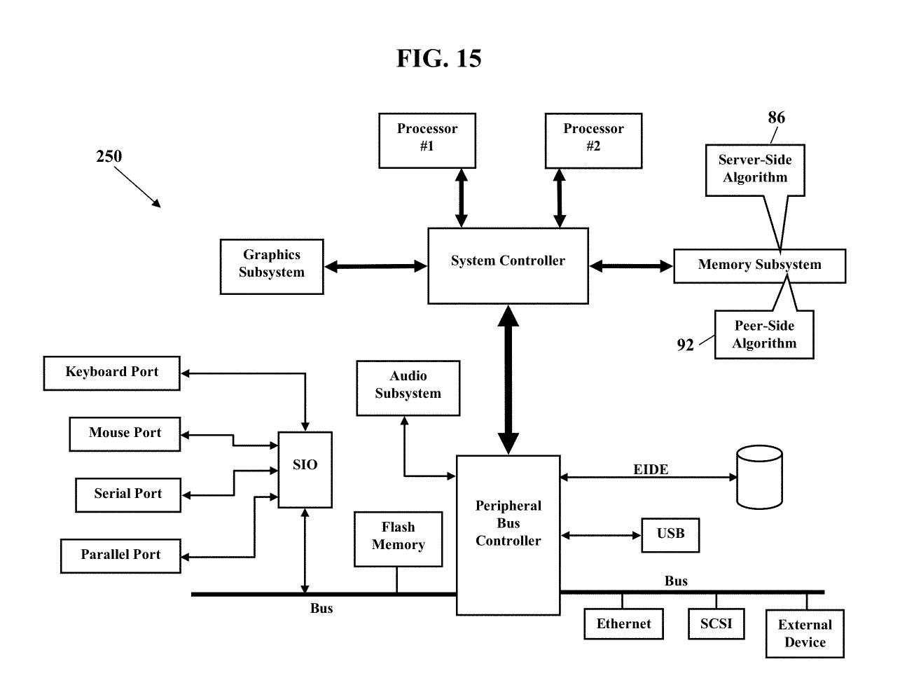

FIG. 15 is a schematic illustrating still more exemplary embodiments. FIG. 15 is a more detailed diagram illustrating a processor-controlled device 250. As earlier paragraphs explained, the server-side algorithm 86 and the peer-side algorithm 92 may partially or entirely operate in any mobile or stationary processor-controlled device. FIG. 15, then, illustrates the server-side algorithm 86 and the peer-side algorithm 92 stored in a memory subsystem of the processor-controlled device 250. One or more processors communicate with the memory subsystem and execute either, some, or all applications. Because the processor-controlled device 250 is well known to those of ordinary skill in the art, no further explanation is needed.

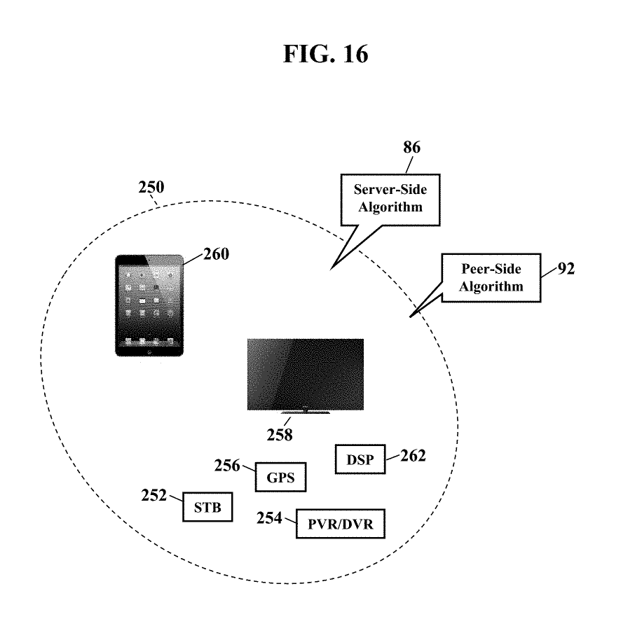

FIG. 16 depicts other possible operating environments for additional aspects of the exemplary embodiments. FIG. 16 illustrates the server-side algorithm 86 and the peer-side algorithm 92 operating within various other processor-controlled devices 250. FIG. 16, for example, illustrates that the server-side algorithm 86 and the peer-side algorithm 92 may entirely or partially operate within a set-top box (“STB”) (252), a personal/digital video recorder (PVR/DVR) 254, a Global Positioning System (GPS) device 256, an interactive television 258, a tablet computer 260, or any computer system, communications device, or processor-controlled device utilizing any of the processors above described and/or a digital signal processor (DP/DSP) 262. Moreover, the processor-controlled device 250 may also include wearable devices (such as watches), radios, vehicle electronics, clocks, printers, gateways, mobile/implantable medical devices, and other apparatuses and systems. Because the architecture and operating principles of the various devices 250 are well known, the hardware and software componentry of the various devices 250 are not further shown and described.

Exemplary embodiments may be applied to any signaling standard. Most readers are thought familiar with the Global System for Mobile (GSM) communications signaling standard. Those of ordinary skill in the art, however, also recognize that exemplary embodiments are equally applicable to any communications device utilizing the Time Division Multiple Access signaling standard, the Code Division Multiple Access signaling standard, the “dual-mode” GSM-ANSI Interoperability Team (GAIT) signaling standard, or any variant of the GSM/CDMA/TDMA signaling standard. Exemplary embodiments may also be applied to other standards, such as the I.E.E.E. 802 family of standards, the Industrial, Scientific, and Medical band of the electromagnetic spectrum, BLUETOOTH®, and any other.

Exemplary embodiments may be physically embodied on or in a computer-readable storage medium. This computer-readable medium, for example, may include CD-ROM, DVD, tape, cassette, floppy disk, optical disk, memory card, memory drive, and large-capacity disks. This computer-readable medium, or media, could be distributed to end-subscribers, licensees, and assignees. A computer program product comprises processor-executable instructions for sourcing mortgage documents, as the above paragraphs explained.

While the exemplary embodiments have been described with respect to various features, aspects, and embodiments, those skilled and unskilled in the art will recognize the exemplary embodiments are not so limited. Other variations, modifications, and alternative embodiments may be made without departing from the spirit and scope of the exemplary embodiments.

1. A method of sourcing an electronic mortgage application, the method comprising:
receiving, by a hardware processor, a blockchain having a cryptographic source key integrated therein;
querying, by the hardware processor, an electronic database for the cryptographic source key integrated in the blockchain, the electronic database electronically associating sourcing data to cryptographic source keys including the cryptographic source key integrated in the blockchain; and
identifying, by the hardware processor, the sourcing data in the electronic database that is electronically associated with the cryptographic source key integrated in the blockchain;
wherein the sourcing data identifies a network source that stores the electronic mortgage application.

2. The method of claim 1, further comprising generating a query specifying the electronic mortgage application.

3. The method of claim 2, further comprising sending the query specifying the electronic mortgage application to the sourcing data identified in the electronic database.

4. The method of claim 2, further comprising routing the query to the sourcing data identified in the electronic database.

5. The method of claim 1, further comprising querying the network source for the electronic mortgage application.

6. The method of claim 1, further comprising retrieving the electronic mortgage application from the network source identified by the sourcing data.

7. A system, comprising:
a hardware processor; and
a memory device, the memory device storing instructions, the instructions when executed causing the hardware processor to perform operations, the operations comprising:
retrieving metadata associated with an electronic mortgage application, the metadata describing sourcing data associated with a network source storing the electronic mortgage application;
generating a cryptographic source key in response to hashing the sourcing data using an electronic representation of a hash function; and
distributing the cryptographic source key via a blockchain;
wherein the blockchain distributes the cryptographic source key that is based on the sourcing data associated with the network source storing the electronic mortgage application.

8. The system of claim 7, wherein the operations further comprise integrating the cryptographic source key into the blockchain.

9. The system of claim 7, wherein the operations further comprise receiving a query specifying the sourcing data that was hashed to generate the cryptographic source key.

10. The system of claim 7, wherein the operations further comprise receiving a query specifying the sourcing data that was hashed and distributed via the blockchain.

11. The system of claim 7, wherein the operations further comprise retrieving the electronic mortgage application.

12. The system of claim 7, wherein the operations further comprise hashing the metadata using the electronic representation of the hash function.

13. The system of claim 12, wherein the operations further comprise generating hash values in response to the hashing of the metadata.

14. The system of claim 13, wherein the operations further comprise integrating the hash values in the blockchain.

15. A memory device storing instructions that when executed cause a hardware processor to perform operations, the operations comprising:
receiving a blockchain having a series of cryptographic source keys integrated therein, the cryptographic source keys generated from hashing metadata associated with electronic mortgage documents using an electronic representation of a hash function;
querying an electronic database for each one of the cryptographic source keys integrated in the blockchain, the electronic database electronically associating sourcing data to the cryptographic source keys; and
identifying the sourcing data in the electronic database that is electronically associated with the cryptographic source keys integrated in the blockchain;
wherein the sourcing data identifies network sources that store the electronic mortgage documents.

16. The memory device of claim 15, wherein the operations further comprise querying the network sources associated with the sourcing data identified in the electronic database.

17. The memory device of claim 15, wherein the operations further comprise retrieving the electronic mortgage documents that correspond to the cryptographic source keys integrated in the blockchain.

18. The memory device of claim 17, wherein the operations further comprise arranging the electronic mortgage documents according to the series of the cryptographic source keys integrated in the blockchain.

19. The memory device of claim 15, wherein the operations further comprise retrieving the electronic mortgage documents that correspond to the sourcing data identified in the electronic database.

20. The memory device of claim 19, wherein the operations further comprise arranging the electronic mortgage documents according to the series of the cryptographic source keys integrated in the blockchain.
